(19) United States
(12) Patent Application Publication
(10) Pub. No.: US 2007/0222123 A1
(43) Pub. Date: Sep. 27, 2007

(54) Method for Producing Containers Comprising a Narrow Opening and a Long Body by Means of Below Molding or Stretch Below Molding Polypropylene Preforms

(76) Inventors: Christophe Bunel, Octerville sur Mer (FR); Laurent Penet, Octeville sur Mer (FR)

Correspondence Address: SUGHRUE MION, PLLC, 2100 PENNSYLVANIA AVENUE, N.W., SUITE 800, WASHINGTON, DC, 20037, US

(21) Appl. No.: 11/579,139

(22) PCT Filed: Apr. 26, 2005
(86) PCT No.: PCT/FR05/01033

§ 371 Date: Feb. 2, 2007

(30) Foreign Application Priority Data
Apr. 30, 2004 (FR) 0404666

(51) Int. Cl. B29D 22/00

(52) U.S. Cl. 264/572

(57) ABSTRACT

The invention relates to the production of containers (2) comprising a narrow opening and a long body, such as bottles or similar, from polypropylene by means of blow moulding or stretch blow moulding. According to the invention, during the blow moulding or stretch blow moulding step, the polypropylene preform (1) undergoes longitudinal stretching at a ratio (L/1) of between approximately 2 and 3.5 and radial stretching (D/d) at a ratio of between approximately 2 and 3.

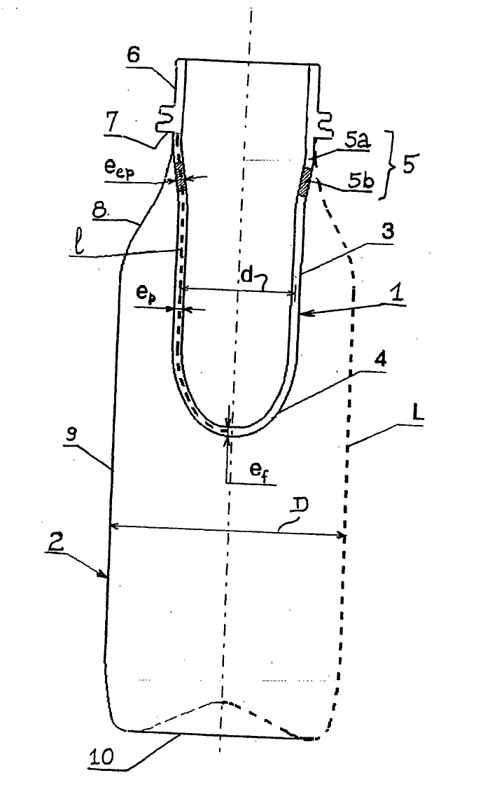

### FIELD OF THE INVENTION

The present invention relates to improvements made in the field of the production of containers comprising a narrow opening and a long body, such as bottles or similar, by means of blow molding or stretch blow molding polypropylene preforms.

### BACKGROUND OF THE INVENTION

It is known to produce containers, and in particular bottles or similar, by means of blow molding or stretch blow molding from preforms made from various materials. The material which is used most frequently nowadays is polyethylene terephthalate (PET) due to certain very advantageous properties of bottles made from this material (namely their good mechanical resistance, allowing them to contain carbonated drinks, the facility to be filled with a hot liquid, the good transparency of the PET which does not adversely affect the appearance of the liquid which they contain, a relatively good barrier effect to oxygen, etc.).

Nevertheless, PET also has certain drawbacks (such as its relatively low melting temperature, which prevents filling with a liquid which is too hot, its increased permeability to water vapor, which prevents its use for packaging lyophilic products, etc. and also its cost which is high and variable).

Attempts are currently being made, at least for certain applications, to replace PET by other materials which perform better, at least in certain areas, and/or are less costly. Thus attempts have been made to use polypropylene instead of PET, at least for certain applications. For example, polypropylene has a melting temperature which is greater than that of PET (above 120° C. instead of 75° C.) which allows filling with a hotter liquid than in the case of PET, a sterilization treatment or the possibility of reheating the contents by means of microwaves; polypropylene has a feature of impermeability to the passage of water vapor which is much greater (in the order of 5 to 10 times) than that of PET and it may be suitable for packaging lyophilic products. Finally, its cost is less than that of PET, even taking into consideration the clarifying agent which it is desirable to add thereto to remove its natural opalescence.

Nevertheless, whilst polypropylene is nowadays frequently used for the production of food packaging formed by molding or by extrusion blow molding, its use for the production of containers by blow molding or stretch blow molding from a preform has only proved successful in the case of containers comprising a wide opening and a relatively short body (pot-type container). In contrast, attempts made to produce containers comprising a narrow opening and a long body have resulted in failure (in particular non-uniform shapes from one container to the other) . The phrase “container comprising a narrow opening and a long body”, in the remainder of the present description, is understood to be any container of which the opening has a smaller section than that of its body: this may be a bottle or a similar container such as a can, flask or similar, which has a narrow neck or mouth.

Following research undertaken in this field, the applicant has been able to establish that, to obtain satisfactory containers comprising a narrow opening and a long body, with mass production and with production equipment operating at a high rate (typically the same rate as for the production of the same types of PET containers), it was necessary to have perfect control of the shape of the polypropylene preform, in addition to certain parameters of the blow molding process or stretch blow molding process, while the tolerances in this respect are much greater with PET.

Document WO 03/035368 discloses a method for producing containers comprising a narrow opening and a long body by means of blow molding or stretch blow molding a polypropylene preform, method according to which the preform is subjected to radial stretching at a ratio of between approximately 1.5 and 4.5.

### SUMMARY OF THE INVENTION

The object of the invention, therefore, is to propose means (polypropylene preform and method of blow molding or stretch blow molding said preform) having specific features which ensure that the process for obtaining containers comprising a narrow opening and a long body of impeccable quality is perfectly mastered, including mass production at a high rate, in the same manner as that carried out for the production of similar PET containers.

To this end, the invention proposes a method according to the preamble of claim wherein the preform is subjected to longitudinal stretching at a ratio of between approximately 2 and 3.5, preferably between approximately 2.5 and 3, and radial stretching at a ratio of between approximately 2 and 3, preferably between approximately 2 and 2.5, and wherein the longitudinal stretching ratio is greater than or equal to the radial stretching ratio.

In these conditions, it is desirable that in practice the longitudinal stretching ratio is approximately 2.7 and/or that the radial stretching ratio is approximately 2.3.

The aforementioned arrangements ensure that the polypropylene preform is capable of being subjected to longitudinal stretching as well as radial stretching, making it possible to end up with a container comprising a narrow opening and a long body, such as a bottle or similar, having precisely the desired shape; in other words, it is possible to produce containers comprising a narrow opening and a long body from precisely consistent shapes in mass production and at a rate which is comparable with that implemented for preforms made of PET.

Preferably, so that the controlled deformation of the preform may conform to the desired reference parameters without impairing the properties of the polypropylene, it is provided that the preform is heated such that the difference in temperature between the inside of the wall and the external face of the wall is between approximately 0 and 15° C., preferably approximately 10° C., the temperature inside being preferably greater than the temperature of the external face of the wall (or temperature of the skin).

In these conditions, the blow molding of the preform may be carried out at a blowing pressure which is substantially less than the high pressure (typically in the order of 40×10⁵ Pa), specified for preforms made of PET; thus, the pressure of the blowing fluid may not exceed approximately 20×10⁵ Pa.

Nevertheless, the polypropylene has a thermal conductivity which is markedly lower (approximately half) than that of PET: the natural cooling of the PET containers at the end of the blow molding or stretch blow molding process proves to be insufficient for polypropylene containers which remain hot, and therefore fragile, for longer, which may have drawbacks: for example in the case of filling immediately after removal from the mold and particularly when the mold has cooled such that the wall of its mold cavity is at a temperature, for example, of between 10 and 20 C., typically 15° C., the container risks being damaged and/or deformed: this is why, to eliminate this drawback definitively, it is advantageous that the container is subjected to a cooling step, immediately after having been molded by means of blow molding or stretch blow molding.

### BRIEF DESCRIPTION OF THE DRAWING

The invention will be better understood by reading the following detailed description with reference to the accompanying drawing, in which the only FIGURE is a schematic representation, in diametric section, of an example of a preform, targeted by the invention, associated with a schematic representation of an example of a container comprising a narrow opening and a long body, such as a bottle, flask, can or similar, capable of being obtained by means of blow molding or stretch blow molding the preform.

### DETAILED DESCRIPTION OF THE INVENTION

The only FIGURE of the accompanying drawing shows a polypropylene preform 1 intended for the production of a container 2 comprising a narrow opening and a long body, in this case a bottle, by means of a blow molding or stretch blow molding process. A preform of this type comprises a neck 6 which is formed by a part present on the preform, which part is not modified during the steps of transforming the preform into a container. In the extension of the neck, the preform 1 comprises a zone 5 of which the constituent material will form the shoulder 8 of the container 2; in the example illustrated, this zone 5 comprises a substantially cylindrical first part 5a extended by a substantially tapered second part 5b (shown in gray in the drawing).

This second tapered part is extended by two successive parts 3, 4 respectively forming the body and base of the preform of which the constituent material will be found respectively on the body 9 and on the base 10 of the container 2.

According to the invention, the preform 1 is designed so as to be capable of withstanding, during the blow molding or stretch blow molding process, longitudinal stretching at a ratio (i.e. ratio of the developed half length L of the body of the container 2 to the developed half length l of the body 3 of the preform 1) which is between approximately 2 and 3.5 and radial stretching at a ratio (i.e. ratio of the average diameter D of the body of the container 2 to the average diameter d of the body of the preform 1) which is between approximately 2 and 3.

The developed half length is the dimension of the neutral axis of the wall taken from the bottom 7 (in this case the lower face of the flange) of the neck 6 and the center of the base 4 for the preform 1 (shown by a dotted line in the left half of the preform on the accompanying drawing) or the center of the base 10 for the container 2 (shown by a dotted line in the right half of the container in the accompanying drawing). Similarly, the average diameter is the diameter d of the part of the body 3 of the preform 1 or the diameter D of the part of the body 9 of the container 2 taken on the respective neutral axis.

Advantageously, the best results are obtained for a longitudinal stretching ratio of between approximately 2.5 and 3 and a radial stretching ratio of between approximately 2 and 2.5.

Preferably, so that a sufficiently wide treatment window is formed to satisfy the demands of industrial mass production, it is desirable that the longitudinal stretching ratio is greater than or at least equal to the radial stretching ratio.

In these conditions, in a typical example for implementing the arrangements of the invention, the longitudinal stretching ratio is approximately 2.7, whilst the radial stretching ratio is approximately 2.3.

To make it possible to ensure a production rate of the same size as that permitted by PET, it is desirable that the polypropylene preform 1 has a body 3 of which the wall has a maximum thickness eₚ which is less than approximately 3.5 mm, typically approximately 2.8 mm; it is also desirable that it has a base 4 of which the thickness e_{f} is not greater than approximately 2.2 mm, typically approximately 2 mm.

To ensure that, in the container 2, a correct distribution of the material in the shoulder 8 (intermediate portion between the neck and the body) is obtained, in addition to correct stretching under the neck, it is desirable that the thickness eₑₚ of said portion 5a is, with the thickness eₚ of the wall of the body 3, at a ratio of between approximately 0.9 and 1.1, typically approximately 1. The thickness eₑₚ is defined as being the thickness taken half way up said second part 5b and the thickness eₚ is the maximum thickness of the wall of the body 3 of the preform.

So that the blow molding or stretch blow molding process may take place in satisfactory conditions and so that, in the end, containers comprising a narrow opening and a clear long body are obtained, it is desirable that the preform consists of a polypropylene having a melt flow index in the melted state (denoted MFI by specialists in the field) which is between approximately 8 and 40, preferably between approximately 12 and 30, and typically approximately 20.

When this is desired, a clarifying agent may be added to the polypropylene in a manner known per se, so that the final polypropylene container comprising a narrow opening and a long body no longer has the characteristic opalescence of natural polypropylene and has an acceptable transparency, close to that of a container made of PET.

The invention also proposes a method for producing containers comprising a narrow opening and a long body by means of blow molding or stretch blow molding preforms having the above characteristics in accordance with the invention, a method which consists in that the preform is subjected to longitudinal stretching at a ratio of between approximately 2 and 3.5 and radial stretching at a ratio of between approximately 2 and 3. Preferably, the longitudinal stretching ratio is between approximately 2.5 and 3. Preferably also, the radial stretching ratio is between approximately 2 and 2.5.

Still preferably, the longitudinal stretching ratio (L/l) is greater than or equal to the radial stretching ratio (D/d). In this case, it is advantageous that the longitudinal stretching ratio is approximately 2.7 and/or that the radial stretching ratio is approximately 2.3.

It is desirable, to optimize the conditions of controlled deformation of the preform, that the preform is heated so that the difference in temperature between the inside of the wall and the external face of the wall is between approximately 0 and 15° C., preferably approximately 10° C., the inside temperature being preferably greater than the temperature of the external face of the wall (or skin temperature).

Polypropylene has a lower mechanical resistance than that of the PET, and this feature proves very advantageous within the scope of the blow molding or stretch blow molding process, as these operations may be carried out by using a fluid (typically air) at a pressure which is substantially less than the high pressure (typically in the order of 40×10⁵ Pa) required by blow molding or stretch blow molding a PET preform. A fluid having a pressure not exceeding approximately 20×10⁵ Pa may conceivably be used. A saving on the cost of the plant results, therefore, in which the compressor is less powerful, less bulky and less expensive and consumes less electrical energy. In practice, the pressure of the blowing fluid may be between approximately 10 and 20×10⁵ Pa, typically approximately 15×10⁵ Pa.

Finally, polypropylene has a thermal conductivity which is markedly lower than that of the PET: the natural cooling which the PET containers are subjected to at the end of the blow molding or stretch blow molding process proves to be insufficient for the polypropylene containers which remain hot, and therefore fragile, for longer, which may have drawbacks (for example in the case of filling immediately after the removal from the mold, and most particularly when the mold is cooled so that the wall of its mold cavity is at a temperature of between, for example, 10 and 20° C., typically 15° C., the container risks being damaged and/or deformed); to remove this drawback definitively, it is advantageous that the container comprising a narrow opening and a long body, is subjected to a cooling step, immediately after having been molded by blow molding or stretch blow molding.

1. A method for producing containers (2) comprising a narrow opening and a long body by means of blow molding or stretch blow molding a polypropylene preform, characterized in that the preform is subjected to longitudinal stretching at a ratio of between approximately 2 and 3.5 and radial stretching at a ratio of between approximately 2 and 3.

2. The method according to claim 1, characterized in that the longitudinal stretching ratio is between approximately 2.5 and 3.

3. The method according to claim 1 or 2, characterized in that the radial stretching ratio is between approximately 2 and 2.5.

4. The method according to any one of claims 1 to 3, characterized in that the longitudinal stretching ratio (L/l) is greater than or equal to the radial stretching ratio D/d).

5. The method as claimed in claim 4, characterized in that the longitudinal stretching ratio is approximately 2.7.

6. The method as claimed in claim 4 or 5, characterized in that the radial stretching ratio is approximately 2.3.

7. The method as claimed in any one of claims 1 to 6, characterized in that the preform is heated such that the difference in temperature between the inside of the wall and the external face of the wall is between approximately 0 and 15° C.

8. The method as claimed in claim 7, characterized in that the temperature inside the wall is greater than the temperature of the external face of the wall.

9. The method as claimed in claim 7 or 8, characterized in that the difference in temperature is approximately 10° C.

10. The method as claimed in any one of claims 1 to 9, characterized in that the blowing fluid is at a pressure not exceeding approximately 20×10⁵ Pa.

11. The method as claimed in claim 10, characterized in that the pressure of the blowing fluid is between approximately 10 and 20×10⁵ Pa.

12. The method as claimed in claim 10 or 11, characterized in that the pressure of the blowing fluid is approximately 15×10⁵ Pa.

13. The method as claimed in any one of claims 1 to 12, characterized in that the container (2) comprising a narrow opening and a long body, is subjected to a cooling step, immediately after having been molded by blow molding or stretch blow molding.

14. The method as claimed in any one of claims 1 to 13, characterized in that the container (2) comprising a narrow opening and a long body is produced in a cooled mold so that the wall of its mold cavity is at a temperature of between 10 and 20° C.

15. A polypropylene preform (1) for the production of containers (2) comprising a narrow opening and a long body by means of blow molding or stretch blow molding, for the implementation of the method as claimed in any one of claims 1 to 14, characterized in that it has a body (3) of which the wall has a maximum thickness (eₚ) which is less than approximately 3.5 mm.

16. The preform as claimed in claim 15, characterized in that the maximum thickness (eₚ) of the wall of the body (3) is approximately 2.8 mm.

17. The preform as claimed in claim 15 or 16, characterized in that it has a base (4) of which the thickness (e_{f}) is not greater than approximately 2.2 mm.

18. The preform as claimed in claim 17, characterized in that the thickness (e_{f}) of the base (4) is approximately 2mm.

19. The preform as claimed in any one of claims 15 to 18, characterized in that it has a portion (5b) located between its neck (6) and its body (3), of which the ratio of the thickness (eₑₚ) to the thickness (eₚ) of the wall of the body (3) is between approximately 0.9 and 1.1.

20. The preform as claimed in claim 19, characterized in that the ratio is approximately 1.

21. The preform as claimed in any one of claims 15 to 20, characterized in that it consists of a polypropylene having a melt flow index in the melted state which is between approximately 8 and 40.

22. The preform as claimed in claim 21, characterized in that the melt flow index is between 12 and 30.

23. The preform as claimed in claim 22, characterized in that the melt flow index is approximately 20.

24. The preform as claimed in any one of claims 15 to 23, characterized in that the polypropylene contains a clarifying agent.
